(19) United States
(12) Patent Application Publication
(10) Pub. No.: US 2012/0169458 A1
(43) Pub. Date: Jul. 5, 2012

(54) Method and System for Monitoring Physical Security and Notifying if Anomalies

(75) Inventors: Richard L. Dubois, JR., Chester, NH (US); Michael Morley, Deerfield, NH (US); Fred Morris Welsh, JR., Flower Mound, TX (US)

(73) Assignee: SCHNEIDER ELECTRIC BUILDINGS AB, MALMO (SE)

(21) Appl. No.: 12/982,925

(22) Filed: Dec. 31, 2010

(51) Int. Cl. G08B 29/00; G08B 19/00

(52) U.S. Cl. 340/5.3; 340/5.2; 340/5.6; 340/5.51

(57) ABSTRACT

A method and system for monitoring access requests for physical access to a location includes a plurality of access control devices for control accessing to specific locations. The system determines if access is authorized based on comparing information associated with the request with a database. Access is granted to a physical location based on the comparison of information. In addition, the system compares an access request to prior access requests. The system determines if the access request is an anomaly from previous requests. If the access request is an anomaly from previous requests, the system notifies an operator that the access request is an anomaly.

### FIELD OF THE INVENTION

This invention relates to physical security and access control and, in particular, the monitoring and analysis to detect anomalies from routine behaviors.

### BACKGROUND OF THE INVENTION

It is common to limit access to physical locations through access control systems. The access control systems can vary in complexity from a latch a child cannot reach to biometrics such as a fingerprint or retina reader. Some of the more common systems include a proximity card and or multiple authentication factors, where the card or other authentication factors are tied to a particular individual.

In some systems the time, user, description of the event (access granted/access denied), and the specific location are recorded. The operator of the system can review the data at a later point. The reasons for reviewing the data could be numerous including loss preventions, locating an individual, and proof of entry for an investigation.

### SUMMARY OF THE INVENTION

It has been recognized that it would be desirable to be notified in near real time of certain situations. The system examines in near real time the data of access and requests for access to secured locations. The system analyzes the information and determines if there is an anomaly that deviates from the standard historical pattern for a particular user. If an anomaly is detected, the system notifies an operator in real time.

In an embodiment of a security system for detecting changes in patterns of access requests according to the invention, the system has at least one access control device for controlling the flow of items in a physical setting. The system has a control system for receiving information from the at least one access control device and determining if access is to be granted. A database collects information regarding access. An analytical system analyzes the data gathered to determine patterns and variations from the patterns. The system has a notification system for notifying of anomalies in the patterns.

In an embodiment, the analytical system examines current requests and historical data.

In an embodiment, the items being monitored for flow are personnel. In an embodiment, the items being monitored for flow are equipment.

In an embodiment, the criteria can be adjusted as to when events are considered an anomaly and the type of notification for such an anomaly.

In an embodiment, at least one of the access control devices is a key pad access control device. In an embodiment, at least one of the access control devices is a RFID (radio frequency identification device) including a transmitter and a receiver device. In an embodiment, at least one of the access control devices includes a proximity card and associated card reader.

In a method of detecting changes in patterns of access requests according to the invention, an access request is compared to prior access requests. It is determined if the access request is an anomaly from previous requests. An operator is notified if the access request is an anomaly.

In an embodiment, an access request is received from an access control device for controlling the flow of items in a physical setting. Information associated with the request is compared with a database. Access to a physical location is granted based on the comparison of information.

In an embodiment, the system notifies an operator of any denied access request.

In an embodiment, the anomaly is determined based on factors including the time of day. In an embodiment, the anomaly is determined based on factors including the day of week. In an embodiment, the anomaly is determined based on factors including activity of others at the same time period. In an embodiment, the anomaly is determined based on factors including the number of previous requests at the requested access point.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic of a system for analyzing a building's physical system according to the invention;

FIG. 2 is a schematic of a method for detecting anomalies;

FIG. 3 shows a pictorial display of a building's security system; and

FIG. 4 shows a pictorial display of an industrial complex security system.

### DETAILED DESCRIPTION OF PREFERRED EMBODIMENTS

The system and method of the present invention monitors access requests for physical access to a location including a plurality of access control devices for controlling access to specific locations. The system determines if access is authorized based on comparing information associated with the request to a database. Access is granted to a physical location based on the comparison of information. In addition, the system compares an access request to prior access requests. The system determines if the access request is an anomaly from previous requests. If the access request is an anomaly from previous requests, the system notifies an operator.

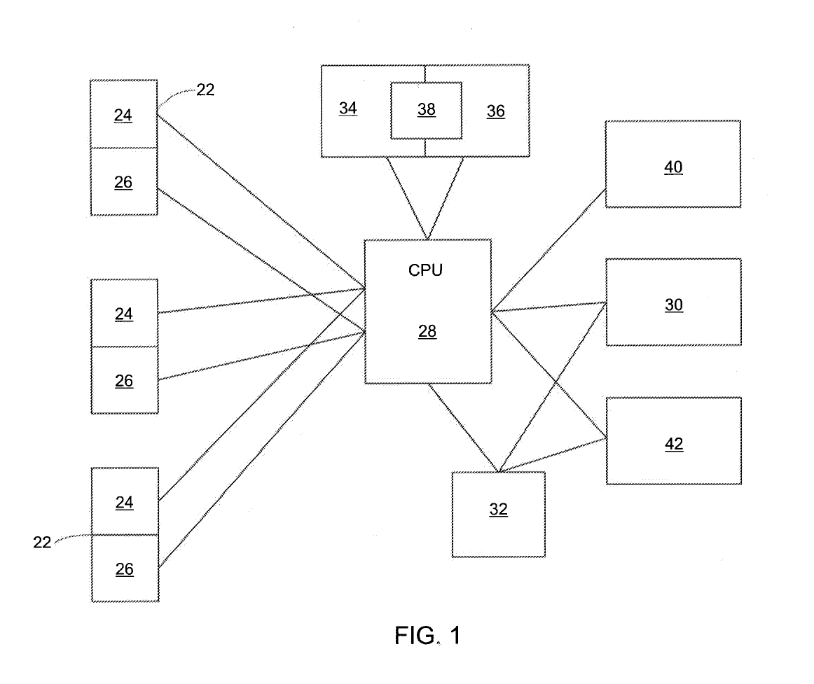

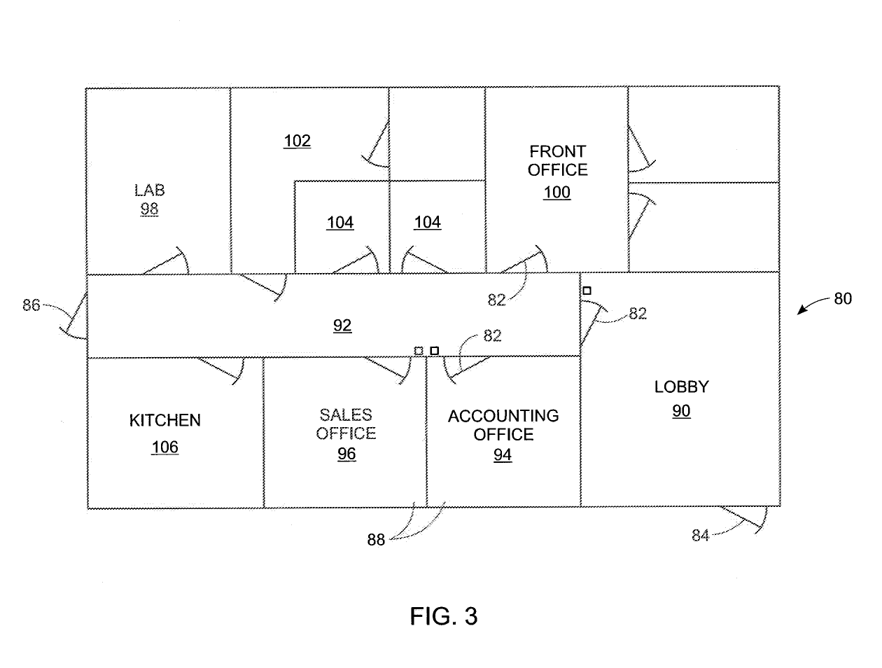

Referring to FIG. 1, a schematic of a system 20 for analyzing a building's physical system, such as a building 80 shown in FIG. 3, is shown. The system 20 has a plurality of access control devices 22 including an input mechanism 24 and an access restrictor or output device 26 for monitoring and granting access to locations. In order to gain access to certain physical locations, a user needs to provide authentication to the access control device 22 through the input mechanism 24. The authentication can be in various forms including, but not limited to a proximity card that is placed in proximity to a proximity card reader which is part of the input mechanism 24. Another alternative is a key pad or swipe card reader in which the user either enters their code or swipes their card. Other potential alternatives include RFID, biometrics, and video analytics.

The system 20 has a controller or central processing unit 28 for controlling the system 20. The CPU 28 accesses a database 30 that contains information related to access privileges and the information received from the input mechanism 24 of the access control device 22 is compared to determine if the access restrictor or output device 26 should be set to allow access. The access restrictor or output device 26 could be an electronic latch, magnetic latch, or gate.

The system 20 in addition has an analysis unit 32 which studies data regarding granting and denying physical access for trends and anomalies. When the analysis unit 32 notices an anomaly as explained in more detail below, the system 20 can notify an operator in real time of the anomaly. In addition, the system 20 gathers data that can be studied in further detail.

Still referring to FIG. 1, the system 20 includes an interface device 34 for receiving operator input and a graphical display screen 36 for displaying information to allow an operator to control the system 20. In one embodiment, the interface device 34 is a keyboard and a pointer controller such as a mouse or tracker ball. In another embodiment, the interface device 34 and the graphical display screen 36 are incorporated into one device such as a touch screen 38.

The system 20 in addition to the access database 30 contains other databases including a building database 40 and a historical database 42. The building database 40 contains information regarding the building and can include relative locations of access points and information for portraying the building graphically. The historical database 42 is written to when access is requested and logs the outcome of the request as explained in further detail below.

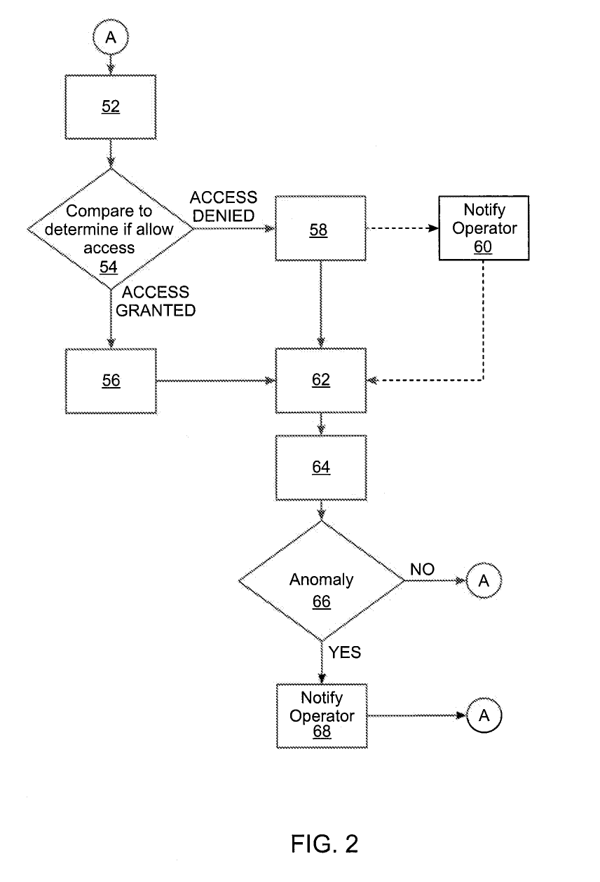

Referring to FIG. 2, a schematic of a method for detecting anomalies is shown. The system 20 receives a request to grant access to a specific location from an input mechanism for a particular door 82 in the building 80 as seen in FIG. 3 and as represented by block 52 as seen in FIG. 2. The system 20 compares the request for authorization as stored in the access database 30 as seen in FIG. 1 and represented by decision diamond 54. If the authorization is proper, the system 20 grants access to the user by sending a signal through access restrictor 26, as represented by block 56. If the authorization is not proper, the system does not grant access through the access restrictor 26, as represented by block 58. In one embodiment, the system 20 notifies an operator through the graphic display 36 as seen in FIG. 1 in real time if someone attempts to access a location not authorized, as represented by block 60 in FIG. 2.

Still referring to FIG. 2, regardless of whether the system 20 grants access or not, the request and result are recorded in the historic database 42, as seen in FIG. 1, and represented by block 62 of FIG. 2. The system 20 through the CPU 28 and the analysis unit 32 examines the current event, that of the request for access, and looks at prior events stored in the historic database 42 as represented by block 64. The system 20 determines if the event is an anomaly as in decision diamond 66. If the system determines it is not an anomaly, the system 20 continues to monitor for access requests from the input mechanism 24 of the access control device 22. If the system 20 determines the request is an anomaly as represented by the yes branch from the decision diamond 66, the system 20 notifies the operator as represented by block 68. The type of notification can depend on the type and grade of anomaly as described below.

The system 20 continues to monitor for access requests from the input mechanism 24 of the access control devices 24 of the system. The operator can adjust the criteria of an anomaly.

Referring to FIG. 3, a pictorial display of the security systems 20 for a building 80 is shown. In this simplistic representation, a building 80 is shown having a front entrance 84 and a back entrance 86. In addition, the building 80 has a plurality of rooms 88 some of which have access control devices 22. In addition, the building 80 has an access control device 22 between a front lobby 90 and a hallway 92; this door is referenced as 108. It recognized during the business day certain access control devices 22 may be switched to another mode where the system 20 does not limit access between specific locations such as between the lobby 90 and the hallway 92 or, in the alternative, the front entrance 84.

In this embodiment, each employee has a proximity card that is required to open certain doors, such as an accounting office 94, a sales office 96, a lab 98, a front office suite 100, and a facilities/IT suite 102. Other locations such as restrooms 104 and a kitchen 106 do not have an access system. As way of an example, John Employee has a proximity card that grants him access to the accounting office 94, the sales office 96, and the front office suite 100 in addition to the outside doors 84 and 86 and the lobby door 108.

The system 20 for a time period, such as several weeks or several months, has been collecting information regarding John Employee's pattern of access. If John arrives on a non-business day and uses his card to enter the back entrance 86 and the sales office 96, the system 20 may note it as an anomaly using the analysis unit 32. The system 20 would allow John access by comparing his card to the access database 30. Referring to FIG. 2, at decision diamond 54, the path followed would be to the access grant block 56. However at the decision diamond 66, the system 20 based on analysis in the analysis unit and the historical database 42 would issue a notification. The notification could be entered in a report. Likewise, if John also attempts to enter the front office suite 100, the system 20 would grant him access but also issue a notification. However, the system 20 may have different levels of notification and in addition to placing an entry in a log, the system may send a page or text message to an operator.

It is recognized that the system 20 may have specific information in the access database 30 related to time, such as certain times that certain employees, such as John, have access to the front suites.

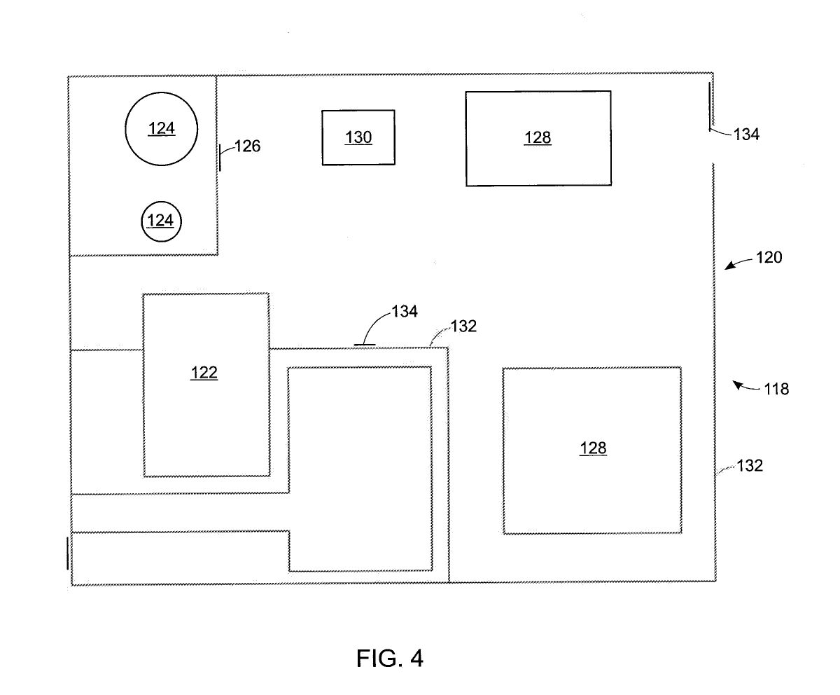

Referring to FIG. 4, a pictorial display of an industrial complex 120 and its associated security system 118 is shown. It is recognized that the industrial complex 120 as shown in FIG. 4 would have numerous more employees and control access points using the access control device 22 than the building 80 shown in FIG. 3. The representation shown in FIG. 4 shows a main office building 122 that could have many stories and various suites including sales, accounting, labs, and computer, all with specific access requirements. In addition, individual labs may have different access requirements or individual rooms within suites may have access requirements. Likewise, the system could have other items such as storage tanks 124 and associated gates 126 that would have additional or different requirements. Likewise, other facilities such as manufacturing buildings 128 or paint locker buildings 130 could have additional requirements. Likewise, the industrial site 120 could have various types of gates 134 in walls or fences to limit access to particular areas of the site.

The system 118 would work similar to the system described above with respect to the building 80 of FIG. 3. It is recognized that the number of requests for access as represented by block 52 for the industrial complex 120 would be greater than the building 80 shown in FIG. 3. The analysis unit 32, while working in a similar manner, would typically be doing more analysis in a specific time period.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized in addition to particular times of access, the anomaly could relate to other factors such as the number of a particular event. For example, John Employee may be allowed in the sales office 96 during normal business hours based on previous events. However, if John Employee entered the sales office 96 six times in a morning where the normal times of entry is zero or one time a day, the system 20 could notify an operator.

What is claimed is:

1. A security system for detecting changes in patterns of access requests, the system comprising:
at least one access control device for controlling the flow of items in a physical setting;
a control system for receiving information from the at least one access control device and determining if access is to be granted;
a database for collecting information regarding access;
an analytical system for analyzing the data gathered to determine patterns and variations from the patterns; and
a notification system for notifying of an anomaly in the patterns.

2. A security system of claim 1 wherein the analytical system examines current requests and historical data.

3. A security system of claim 1 where the items being monitored for flow are personnel.

4. A security system of claim 1 wherein the items being monitored for flow are equipment.

5. A security system of claim 1 wherein criteria can be adjusted as to when events are considered an anomaly and the type of notification for such an anomaly.

6. A security system of claim 1 wherein the at least one access control device is a key pad access control device.

7. A security system of claim 1 wherein the at least one access control device is RFID (radio frequency identification device) including a transmitter and a receiver device.

8. A security system of claim 1 wherein the at least one access control device includes a proximity card and associated card reader.

9. A method of detecting changes in patterns of access request comprising:
comparing an access request to prior access requests;
determining if the access request is an anomaly from previous requests; and
notifying an operator if the access request is an anomaly.

10. A method of claim 9 further comprising:
receiving an access request from an access control device for controlling the flow of items in a physical setting;
comparing information associated with the request with a database; and
granting access to a physical location based on the comparison of information.

11. A method of claim 10 wherein the system notifies an operator of any denied access request.

12. A method of claim 9 wherein the anomaly is determined based on factors including the time of day.

13. A method of claim 9 wherein the anomaly is determined based on factors including the day of week.

14. A method of claim 9 wherein the anomaly is determined based on factors including activity of others at the same time period.

15. A method of claim 9 wherein the anomaly is determined based on factors including the number of previous requests at the requested access point.
